(19) United States
(12) Patent Application Publication
(10) Pub. No.: US 2010/0126430 A1
(43) Pub. Date: May 27, 2010

(54) PROTECTING DEVICE FOR ANIMAL RESTRAINTS

(76) Inventor: Leslie R. Munroe, Blandford, MA (US)

Correspondence Address: CANTOR COLBURN, LLP, 20 Church Street, 22nd Floor, Hartford, CT, 06103, US

(21) Appl. No.: 12/276,546

(22) Filed: Nov. 24, 2008

(51) Int. Cl. A01K 13/00; A01K 27/00

(52) U.S. Cl. 119/795; 119/850; 119/712

(57) ABSTRACT

A protecting device for animal restraints comprises a generally planar main piece of flexible, resilient material. The protecting device is provided with an attachment portion configured to allow selective attachment and detachment of opposite sides of the main piece to each other in order to form a generally cylindrical shape. The protecting device is further provided with an irregular outer surface.

### TECHNICAL FIELD OF INVENTION

The invention concerns a protecting device for an animal restraint, more particularly, a protecting device for protecting said animal restraint and the respective animal from damage caused by actions such as chewing upon the restraint.

### BACKGROUND OF INVENTION

Animal restraining devices are widely used to control the radius of an animal's movement relative to a stable point or to a moving object, such as a human. These restraining devices are usually made from either rigid materials, such as metal chain links, or non-rigid materials, such as nylon rope. A common such animal restraining device is a leash which at one end attaches to an animal, such as a dog, while the other end may be carried by the dog walker.

Animal restraining devices made from rigid materials usually offer the advantage of being resilient to damage caused by the animal. However, the resiliency of the retraint can play a factor in causing physical harm to an animal if the restraint is chewed upon. For example, the teeth, gums, etc., of a dog may be damaged when the dog chews excessively upon a leash made of chain links.

Non-rigid animal restraining devices, compared to rigid restraining devices, generally offer the advantage of imparting less physical damage to an animal if the restraint is chewed upon. However, this property allows for the animal to cause a greater degree of damage to the non-rigid restraining device, compared to a rigid restraining device. For example, it has been known for a dog to chew entirely through a woven leash, thus freeing the dog from the restraint.

Accordingly, a device is needed to protect both the animal and/or the animal restraining device from damage caused by actions such as chewing.

### BRIEF SUMMARY OF THE INVENTION

In general, one embodiment of the present invention provides a protecting device for an animal restraint comprising a generally planer main piece. The main piece may be composed of a flexible yet resilient material. On the main piece, an attachment portion is included. This attachment portion is configured to allow selective attaching and detaching of opposite sections of the main piece to each other. The inclusion of an attachment portion facilitates the formation of the main piece into a generally cylindrical shape. Furthermore, the main piece is provided with an irregular outer surface.

In general, an alternate embodiment of the present invention provides a protecting device for an animal restraint comprising a generally cylindrical main piece. The cylindrical main piece may be composed of a flexible yet resilient material. Furthermore, the cylindrical main piece contains a cavity extending through an inner portion of the main piece. The cavity in the main piece is configured to receive and retain an animal restraint. In addition, the cylindrical main piece comprises an irregular outer surface.

### BRIEF DESCRIPTION OF THE FIGURES

FIG. 1 is a front top side view of a first embodiment.

FIG. 2 is an angled top view of a second embodiment.

### DETAILED DESCRIPTION OF THE INVENTION

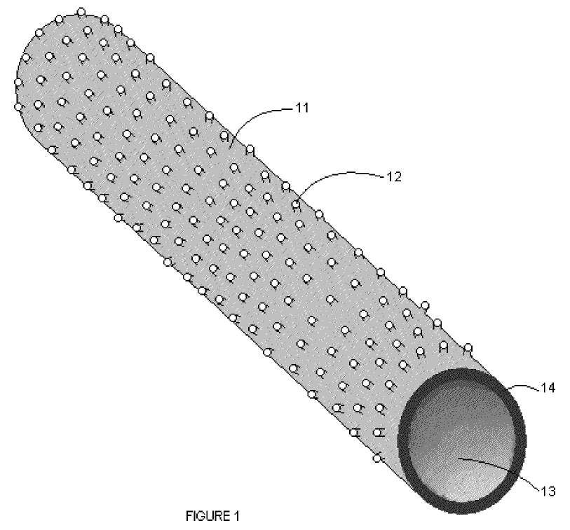

A general representation of a first embodiment is shown in FIG. 1. A protecting device for animal restraints 14 comprises a preformed cylindrical tube of flexible, resilient material. This tube shaped protecting device 14 includes a hollow inner portion 13. The hollow inner portion 13 is formed in order to allow through passage of some section of an animal restraining device (not shown). An outer surface 11 of the preformed tube may be configured to be an irregular outer surface. FIG. 1 shows an outer surface 11 with an aforementioned irregular configuration. In FIG. 1, the irregularity is provided by a plurality of protuberances 12. However, the protuberances 12 are for illustrative purposes only, the irregular outer surface 11 may comprise any size and number of elevations or depressions, and the irregular outer surface 11 need not be consistent in its type of irregularity. The outer surface 11 is provided as an irregular outer surface in order to attract an animal to chew on the protecting device instead of the corresponding animal restraint. Furthermore, the hollow inner portion 13, need not be smooth, as shown, instead the portion 13 may be constructed in any fashion as long as through passage of some section of an animal restraining device is allowed.

In practice, the animal restraint is fed through the hollow inner portion 13 of the protecting device 14 wherein the protecting device rests on the animal end of the restraint. In this configuration the protecting device can serve as a barrier between the animal and a portion of the restraint accessible to the animal. Furthermore, the irregular outer surface 11 attracts the animal to chew on the protecting device as opposed to an exposed area of the animal restraint. Use of the protecting device in the abovementioned way combined with the inherent properties of the protecting device results in the protection of teeth, gums, etc. of the animal, and the animal restraint.

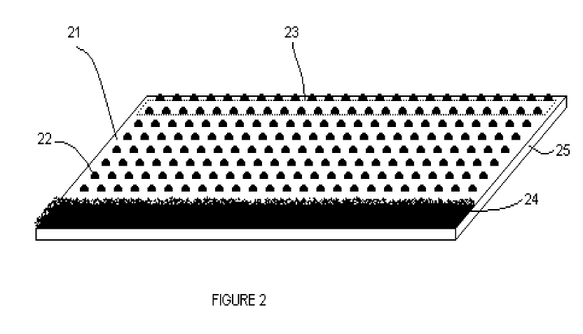

A general representation of a second embodiment is shown in FIG. 2. A protecting device for animal restraints 25 comprises a generally rectangular piece of flexible, resilient material. The protecting device 25 is configured with an attachment portion 24, and a corresponding attachment portion (not shown). Attachment portion 24 and the corresponding portion are configured to allow selective attachment and detachment of opposite sides of the protecting device 25. The attachment portions allow the device 25 to securely wrap around a section of an animal restraint. Specifically, FIG. 2 depicts the attachment portions comprising a plurality of hook and loop fasteners. The plurality of loops is represented by 24, while the corresponding plurality of hooks (not shown) is positioned underneath stitching 23. However, the attachment portions need not be a plurality of hooks and loops; they may be of any type suitable for the purpose. For example the attachment portions may comprise zippers, snaps, buttons, etc. Similar to the protecting device generally shown in FIG. 1, the protecting device 25 is provided with an irregular outer surface 21. In FIG. 2, the irregularity is provided by a plurality of bumps 22. This is not meant to be limiting; the irregular surface may comprise any size and number of elevations or depressions, and the irregular surface need not be consistent in its type of irregularity.

In practice, the protecting device 25 is applied to the animal end of an animal restraint. The protecting device 25 is placed around the animal restraint with the irregular outer surface 21 facing away from the restraint. The protecting device is then secured around the animal end of the restraint via the corresponding attachment portions. In this configuration the protecting device can serve as a barrier between the animal and a portion of the restraint accessible to the animal. Furthermore, the irregular outer surface 21 attracts the animal to chew on the protecting device instead of an exposed area of the animal restraint. Use of the protecting device in the abovementioned way combined with the inherent properties of the protecting device results in the protection of the teeth, gums, etc. of the animal, and the animal restraint.

A third embodiment is imagined wherein the protecting device is formed integrally with the animal restraint. In this embodiment the protecting device is fixed in place on the restraint as a result of relatively permanent attachment between the restraint and the protecting device. This attachment may be accomplished in a variety of manners. For example, the protecting device may be integrally molded as a part of the restraint, the device may be adhesively attached to the restraint, the device may be sewn to the restraint, etc. The protecting device of this embodiment, similar to the first and second embodiments, is provided with an irregular outer surface. This surface attracts the animal to chew on the protecting device instead of the restraint, thereby protecting the teeth, gums, etc. of the animal, and the animal restraint.

The protecting device described herein may be constructed in various sizes, various thicknesses, and of any desired material strong enough to resist damage due to actions such as chewing on the device. For example the dimensions may be approximately 10 inches long, 4 inches wide, and ⅛ inch thick. Furthermore, protuberances comprising an irregular outer surface may extend approximately 3/16-⅛ inch above a planer outer surface.

The protecting device as described herein is preferably intended for use with a dog and generally flexible animal restraint. However, the protecting device may be used with any animal and any type of restraint where it is appropriate to protect a restraint from damage and an animal from harm. For example, the protecting device may be used with a horse, or with a leash generally used with guide dogs for the visually impaired.

It will be apparent to those skilled in the art that, while exemplary embodiments have been shown and described, various modifications and variations can be made to the present apparatus disclosed herein without departing from the spirit or scope of the invention. Accordingly, it is to be understood that the various embodiments have been described by way of illustration and not limitation.

1. A protecting device for an animal restraint comprising:
a generally planar main piece composed of flexible, resilient material;
an attachment portion configured for selectively attaching and detaching opposite sections of said main piece to each other, in order to form said main piece into a generally cylindrical shape; and
an irregular outer surface on said main piece.

2. The protecting device for an animal restraint of claim 1, wherein said protecting device is configured to be attached to a dog leash.

3. The protecting device for an animal restraint of claim 1, wherein said protecting device is configured to protect the animal restraint from damage and the animal from harm.

4. The protecting device for an animal restraint of claim 1, wherein said irregular outer surface comprises a plurality of dome shaped projections.

5. The protecting device for an animal restraint of claim 1, wherein said irregular outer surface is configured to attract an animal to chew on said protecting device as opposed to the animal restraint.

6. The protecting device for an animal restraint of claim 1, wherein said attachment portion comprises a separate piece connected to said protecting device via stitching.

7. A protecting device for an animal restraint comprising:
a generally cylindrical main piece composed of flexible, resilient material;
said cylindrical main piece containing a cavity extending through an inner portion of said cylindrical main piece, said cavity being configured to receive and retain said animal restraint; and
an irregular outer surface on said cylindrical main piece.

8. The protecting device for an animal restraint of claim 8, wherein said irregular outer surface comprises a plurality of dome shaped projections.

9. The protecting device for an animal restraint of claim 8, wherein said protecting device is configured to be attached to a dog leash.

10. The protecting device for an animal restraint of claim 8, wherein said protecting device is configured to protect the animal restraint from damage and the animal from harm.

11. The protecting device for an animal restraint of claim 8, wherein said irregular outer surface is configured to attract an animal to chew on said protecting device as opposed to the animal restraint.

12. The protecting device for an animal restraint of claim 7, wherein said protecting device is formed integrally on the leash.
